(19) United States
(12) Patent Application Publication
(10) Pub. No.: US 2019/0375408 A1
(43) Pub. Date: Dec. 12, 2019

(54) METHOD AND DEVICE FOR OPERATING AN AUTOMATED VEHICLE AT AN INTERSECTION

(71) Applicant: Robert Bosch GmbH, Stuttgart (DE)

(72) Inventors: Johannes Ruenz, Renningen (DE); Jihad Miramo, Stuttgart (DE)

(21) Appl. No.: 16/433,156

(22) Filed: Jun. 6, 2019

(30) Foreign Application Priority Data
Jun. 7, 2018 (DE) 102018209031.9

(51) Int. Cl. B60W 30/18; G05D 1/00; G08G 1/01

(52) U.S. Cl. CPC B60W 30/18; G05D 1/0088; B60W 2720/106; B60W 2550/22; B60W 2550/12; G08G 1/0125

(57) ABSTRACT

A method and a device for operating an automated vehicle at an intersection including a step of detecting the intersection, a step of determining a traffic volume at the intersection, a step of determining a driving strategy for the automated vehicle, as a function of the intersection and as a function of the traffic volume, and a step of operating the automated vehicle, as a function of the driving strategy.

### CROSS REFERENCE

The present application claims the benefit under 35 U.S.C. § 119 of German Patent Application No. DE 102018209031.1 filed on Jun. 7, 2018, which is expressly incorporated herein by reference in its entirety.

### BACKGROUND INFORMATION

The present invention relates to a method and a device for operating an automated vehicle at an intersection including a step of detecting the intersection, a step of determining a volume of traffic at the intersection, a step of determining a driving strategy for the automated vehicle and a step of operating the automated vehicle as a function of the driving strategy.

### SUMMARY

An example method of the present invention for operating an automated vehicle at an intersection comprises a step of detecting the intersection and a step of determining the volume of traffic at the intersection. The method furthermore comprises a step of determining a driving strategy for the automated vehicle, as a function of the intersection and as a function of the traffic volume, and a step of operating the automated vehicle, as a function of the driving strategy.

An automated vehicle is to be understood as a partially, highly or fully automated vehicle.

An operation of the automated vehicle is to be understood in such a way that the automated vehicle is operated in partially, highly or fully automated fashion. The operation in this context comprises for example determining a trajectory for the automated vehicle and/or driving the trajectory using an automated lateral and/or longitudinal control and/or performing safety-related driving functions, etc.

A traffic volume at the intersection is to be understood for example as at least one further—stopped and/or moving—road user (vehicle, bicycle, pedestrian, etc.), who approaches the intersection and/or is located on the intersection and/or is leaving the intersection. In the context of the present invention, the intersection comprises for example the intersection area itself and/or the traffic routes leading to and away from the intersection within a specified area of the intersection. This area depends for example on a design of the intersection and/or depends on a specified length: for example, the traffic routes leading to and away from the intersection within 10, 20 or 50 meters count as the area of the intersection (the use of the terms “at the intersection” and/or “on the intersection” is to be understood as “in the area of the intersection”). In one specific embodiment, a road user is to be understood only as a motorized or non-motorized vehicle. A non-motorized vehicle is to be understood for example as a bicycle.

The method of the present invention achieves the objective of improving the operation of an automated vehicle at an intersection using the device of the present invention. This results for example in an increased traffic flow in the area of the intersection, a potentially increased driver acceptance (no unnecessary braking), a shorter trip duration, a lower pollutant emission, a lower energy requirement of the automated vehicle, etc. The safety of the automated vehicle and/or the safety of the occupants of the automated vehicle and/or the safety of at least one further road user is furthermore increased.

Preferably, the driving strategy for the automated vehicle is determined in such a way that the driving strategy comprises a deceleration of the automated vehicle at the intersection and/or a speed of the automated vehicle on the intersection.

A driving strategy for the automated vehicle is to be understood for example as a specification as to how the automated vehicle is operated. This is to be understood in particular as a specification as to how the automated vehicle is operated in the area of the intersection. A driving strategy comprises for example at least one of the following specifications: a trajectory along which the automated vehicle is moved by the automated control of a lateral and/or longitudinal control of the automated vehicle, a—positive or negative deceleration of the automated vehicle at the intersection and/or a speed of the automated vehicle on the intersection, a switching on and/or off of at least one signaling device of the automated vehicle (turn indicator, high beam, low beam, etc.), an implementation of at least one safety-related measure (“priming” and/or triggering an airbag, adjusting a safety belt, etc.), etc.

The automated vehicle preferably does not have the right of way at the intersection. This means that the automated vehicle must grant at least one other road user priority at the intersection, for example due to a traffic sign and/or due to provision applicable in the area of the intersection (for example in the sense of road traffic regulations).

The intersection preferably comprises at least one object, which is detected with the intersection, the traffic volume at the intersection being determined as a function of the at least one object. This is to be understood for example in that at least one additional road user is assumed as traffic volume, which is located from the point of view of the automated vehicle behind the at least one object, even though no additional road users are able to be detected directly from the point of view of the automated vehicle.

The traffic volume at the intersection is preferably determined in that first surroundings data values of at least one additional vehicle, which is located on or at the intersection, are received by the automated vehicle, and/or in that second surroundings data values of at least one intersection monitoring device, which is comprised by the intersection, are received, and/or in that traffic volume data values, which are stored in the automated vehicle and/or are received from an external server, are evaluated.

The driving strategy for the automated vehicle preferably is determined as a function of at least one deceleration specification and/or a speed specification from at least one operator of the automated vehicle, and/or of an infrastructure state of the intersection, and/or of a state of th weather at the intersection, and/or of an accident scenario, which is determined as a function of the traffic volume.

In one possible specific embodiment of the present invention, the automated vehicle comprises an environment sensor system, an environment sensor system being understood for example as at least one video sensor and/or at least one radar sensor and/or at least one LIDAR sensor and/or at least one ultrasonic sensor and/or at least one additional sensor, which is designed to sense the surroundings of the automated vehicle in the form of surroundings data values.

An operator is to be understood for example as an occupant of the automated vehicle, the deceleration specification and/or the speed specification having been transmitted for example prior to reaching the intersection by the driver to the automated vehicle. This occurs for example via an input device acoustically and/or haptically and/or visually (depending on the design of the input device) and/or via a smartphone of the operator, which is connected to the automated vehicle by cable and/or wirelessly (Bluetooth, etc.), for example. An infrastructure state of the intersection is for example a state of the road-surface covering and/or a longitudinal dimension of the intersection and/or a position of traffic signs at the intersection and/or a position of pedestrian crossings, etc. A weather state at the intersection is to be understood for example a precipitation on the roadway and/or a visual range due to fog, rain, snow, etc. and/or insolation, etc. The visual range or the insolation here refer for example to the (weather-state-dependent) functioning of at least one sensor of an environment sensor system of the automated vehicle. An accident scenario is for example a possible severity of injury of road users in a possible accident. The driving strategy for the automated vehicle is determined for example in such a way that damage to vehicle body should not be accepted, but that rather an accident as such and/or hard braking actions and or steering actions prior to dangerous situates are avoided and that thus a sense of safety is communicated to an operator of the automated vehicle and/or to other road users.

Preferably, the intersection is detected and/or the traffic volume is determined and/or the driving strategy is determined as a function of a map and/or as a function of a surroundings of the automated vehicle, which is detected by an environment sensor system of the automated vehicle and/or is evaluated using a method based on artificial intelligence.

The device of the present invention for operating an automated vehicle at an intersection comprises first means for detecting the intersection, which the automated vehicle will negotiate, and second means for determining a traffic volume at the intersection. The device furthermore comprises third means for determining a driving strategy for the automated vehicle, as a function of the intersection and as a function of the traffic volume, the driving strategy comprising a deceleration of the automated vehicle before reaching the intersection and/or a speed of the automated vehicle on the intersection, and fourth means for operating the automated vehicle, as a function of the driving strategy.

Preferably, the first means and/or the second means and/or the third means and/or the fourth means are designed to implement a method as described herein.

Advantageous further developments of the present invention are described herein.

### BRIEF DESCRIPTION OF THE DRAWINGS

Exemplary embodiments of the present invention are shown in the figures and explained in greater detail below.

FIG. 1 shows an exemplary embodiment of the device according to the present invention in purely exemplary fashion.

FIG. 2 shows an exemplary embodiment of the method according to the present invention in purely exemplary fashion.

FIG. 3 shows an exemplary embodiment of the method according to the present invention in the form of a flow chart in purely exemplary fashion.

### DETAILED DESCRIPTION OF EXAMPLE EMBODIMENTS

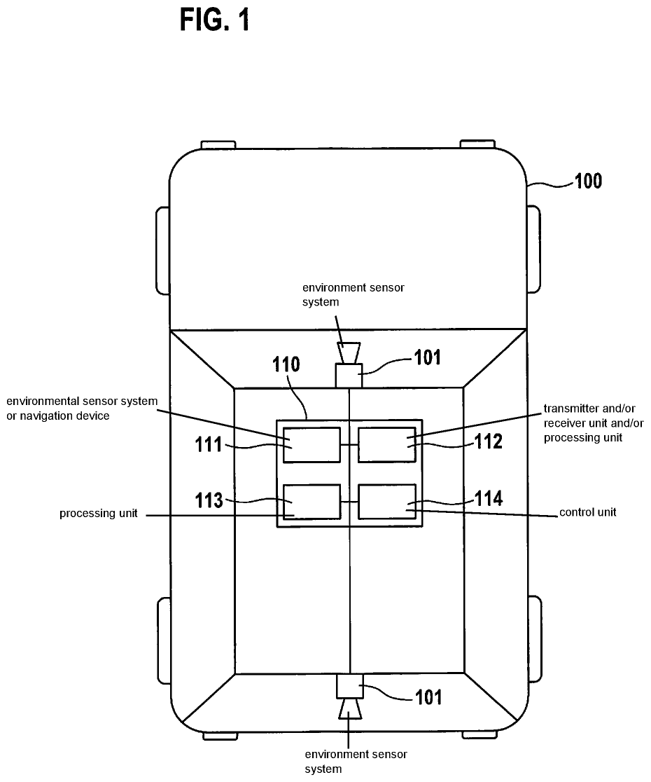

FIG. 1 shows an automated vehicle 100, which comprises the device 110 of the present invention for implementing a method 300 of the present invention.

Device 110 for operating 340 an automated vehicle 100 at an intersection 200 comprises first means 111 for detecting 310 the intersection 200, which the automated vehicle 100 will negotiate, and second means 112 for determining 320 a traffic volume at intersection 200. The device furthermore comprises third means 113 for determining 330 a driving strategy for the automated vehicle 100, as a function of intersection 200 and as a function of the traffic volume, and fourth means 114 for operating 340 the automated vehicle 100, as a function of the driving strategy.

First means 111 for detecting 310 the intersection are developed for example as an environment sensor system, which comprises a processing unit (processor, working memory, hard disk) and suitable software, in order to detect an intersection in the surroundings of the automated vehicle 100 using at least one sensor 101. In another specific embodiment, first means 111 are developed for example additionally and/or alternatively as a navigation device, intersection 200 being detected in that a current and/or a future position of automated vehicle 100 is determined and compared to a map of the navigation device.

Second means 112 for determining 320 a traffic volume are developed for example as a transmitter and/or receiver unit, by which first surroundings data values of at least one further vehicle 210, which is located on or at intersection 200, are received, and/or second surroundings data values of at least one intersection monitoring device 201, which is comprised by intersection 200, are received by automated vehicle 100. In a second specific embodiment, second means 112 are alternatively or additionally developed as a processing unit (processor, working memory, hard disk) having a suitable software. Traffic volume data values are stored on the hard disk for example and/or -depending on the design of second means 112—are received from an external server 250 so that these traffic volume data values may be evaluated. The traffic volume data values comprise for example a time-dependent average traffic volume at intersection 200.

Third means 113 for determining 330 a driving strategy for automated vehicle 100, as a function of intersection 200 and as a function of the traffic volume, are developed for example as a processing unit (processor, working memory, hard disk) having a suitable software. The driving strategy is determined for example in such a way that the driving strategy comprises at least one deceleration of automated vehicle 100 at intersection 200 and/or a speed of automated vehicle 100 on intersection 200.

Fourth means 114 for operating 340 automated vehicle 100, as a function of the driving strategy, are developed for example as a control unit.

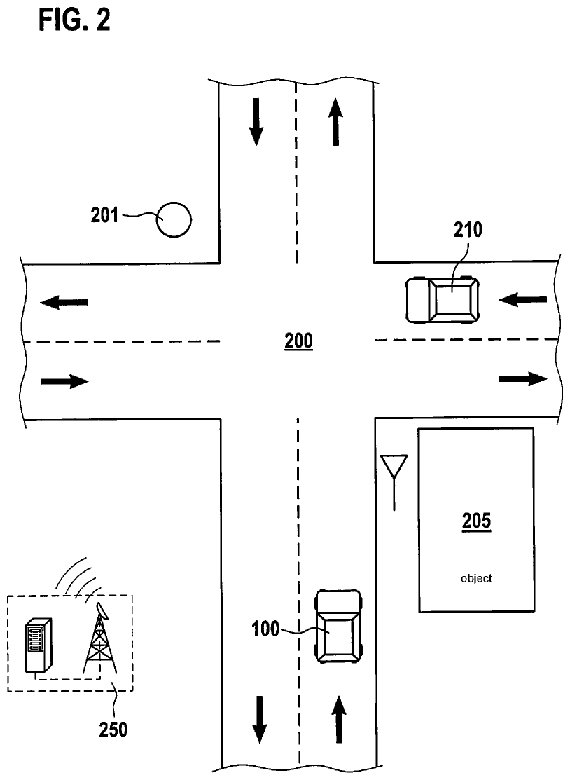

FIG. 2 shows an exemplary embodiment of method 300 of the present invention.

Here an automated vehicle 100 is on a traffic route and approaches an intersection 200. Intersection 200, which is here represented purely by way of example, comprises at least one object 205 and at least one intersection monitoring device 201.

The at least one object is to be understood for example as a building and/or infrastructure device (traffic sign, signaling system, etc.) and/or a tree, forest, bush, etc., the at least one object being comprised by the intersection in particular in such a way that at least one traffic route, which leads to or away from intersection 200, is concealed at least partially and cannot be detected entirely by an environment sensor system 101 of automated vehicle 100. In another specific embodiment, intersection 200 has no such object 205.

The at least one intersection monitoring device 201 is to be understood as a camera for example, which is used for monitoring intersection 200 and/or is designed to detect a traffic volume at intersection 200 in the form of second surroundings data values and to provide or transmit these for example via a transmitter device in such a way that the second surroundings data values are received by automated vehicle 100. In another possible specific embodiment, intersection 200 comprises no intersection monitoring device 201.

Intersection 200 furthermore comprises at least one additional vehicle 210, which detects for example a traffic volume—including its own presence on or at intersection 200—using an environment sensor system comprised by the additional vehicle 210 in the form of first surroundings data values and provides these for example using a transmitter device in such a way that the first surroundings data values are received by automated vehicle 100.

In one specific embodiment, for example, traffic volume data values are transmitted or provided by an external server 250, shown here by way of example, in such a way that these traffic volume data values are received by the automated vehicle 100.

In one specific embodiment, automated vehicle 100 detects intersection 200 for example as a function of a map and/or as a function of a surroundings of automated vehicle 100, which are detected by an environment sensor system (101) of automated vehicle 100. Subsequently, a traffic volume at intersection 200 is determined. This occurs for example in that the first surroundings data values of the at least one additional vehicle 210 are received by automated vehicle 100, and/or in that the second surroundings data values of the at least one intersection monitoring device 201 are received, and/or in that the traffic volume data values, which are stored in automated vehicle 100 and/or are received from external server 250, are evaluated. Subsequently, a driving strategy is determined for automated vehicle 100. This occurs for example as a function of at least one deceleration specification and/or a speed specification from at least one operator of the automated vehicle 100, and/or of an infrastructure state of intersection 200, and/or of a state of the weather, in an area comprising intersection 200, and/or of an accident scenario, which is determined as a function of the traffic volume.

In one possible specific embodiment, the detection 310 of the intersection 200 and/or the determination 320 of the traffic volume and/or the determination 330 of the driving strategy occur as a function of a map and/or as a function of the surroundings of automated vehicle 100, which is detected by an environment sensor system 101 of the automated vehicle 100 and/or is evaluated using a method based on artificial intelligence. An artificial intelligence is to be understood for example as a program, which is comprised by the processing unit of first means 111 and/or second means 112 and/or third means 113 and is designed to determine, for example on the basis of previous and comparable situations such as the negotiation of other intersections, a traffic volume and/or to determine a driving strategy for automated vehicle 100, as a function of intersection 200 and as a function of the traffic volume.

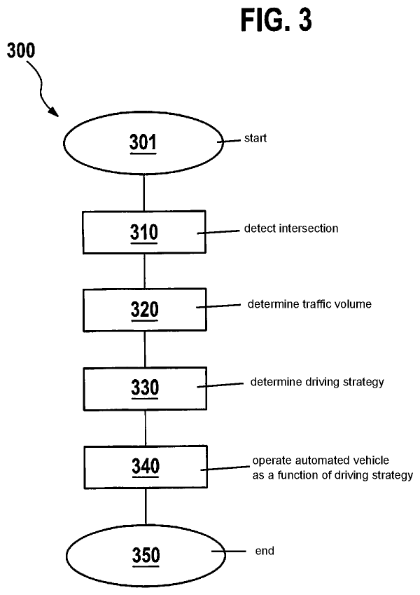

FIG. 3 shows an exemplary embodiment of a method 300 for operating 340 an automated vehicle 100 at an intersection 200.

Method 300 begins with step 301.

In step 310, intersection 200 is detected.

A traffic volume at intersection 200 is determined in step 320.

In step 330, a driving strategy is determined for automated vehicle 100 as a function of intersection (200) and as a function of the traffic volume.

In step 340, automated vehicle 100 is operated as a function of the driving strategy.

Method 300 ends with step 350.

What is claimed is:

1. A method for operating an automated vehicle at an intersection, comprising:
detecting the intersection;
determining a traffic volume at the intersection;
determining a driving strategy for the automated vehicle, as a function of the intersection and as a function of the traffic volume; and
operating the automated vehicle as a function of the driving strategy.

2. The method as recited in claim 1, wherein the determination of the driving strategy for the automated vehicle occurs in such a way that the driving strategy comprises a deceleration of the automated vehicle at the intersection and/or a speed of the automated vehicle on the intersection.

3. The method as recited in claim 1, wherein the automated vehicle does not have the right of way at the intersection.

4. The method as recited in claim 1, wherein the intersection includes at least one object which is detected together with the intersection, and wherein the traffic volume at the intersection is determined as a function of the detected at least one object.

5. The method as recited in claim 1, wherein the determination of the traffic volume at the intersection occurs in that: (i) first surroundings data values of at least one further vehicle, which is located on or at the intersection, are received by the automated vehicle, and/or (ii) second surroundings data values of at least one intersection monitoring device, which is at the intersection, are received, and/or (iii) traffic volume data values, which are stored in the automated vehicle and/or are received from an external server, are evaluated.

6. The method as recited in claim 1, wherein the determination of the driving strategy for the automated vehicle occurs as a function of: (i) at least one deceleration specification and/or a speed specification from at least one operator of the automated vehicle, and/or (ii) an infrastructure state of the intersection, and/or (iii) a state of the weather at the intersection, and/or (iv) an accident scenario, which is determined as a function of the traffic volume.

7. The method as recited in claim 1, wherein the detection of the intersection and/or the determination of the traffic volume and/or the determination of the driving strategy occur: (i) as a function of a map, and/or (ii) as a function of a surroundings of the automated vehicle which are detected by an environment sensor system of the automated vehicle and/or are evaluated using a method based on artificial intelligence.

8. A device for operating an automated vehicle at an intersection, comprising:
first means for detecting the intersection which the automated vehicle will negotiate;
second means for determining a traffic volume at the intersection;
third means for determining a driving strategy for the automated vehicle as a function of the intersection and as a function of the traffic volume; and
fourth means for operating the automated vehicle as a function of the driving strategy.

9. The device as recited in claim 8, wherein the first means and/or the second means and/or the third means and/or the fourth means are configured to implement a method for operating the automated vehicle at the intersection, the first means and/or the second means and/or the third means and of the fourth means configured to:
detect the intersection;
determine the traffic volume at the intersection;
determine the driving strategy for the automated vehicle, as a function of the intersection and as a function of the traffic volume; and
operate the automated vehicle as a function of the driving strategy.
